(19) United States
(12) Patent Application Publication
(10) Pub. No.: US 2009/0126850 A1
(43) Pub. Date: May 21, 2009

(54) LABELLING ARTICLES

(75) Inventors: Malcolm Fletcher, Monmouthshire (GB); Jeffrey David Stover, Monmouthshire (GB)

Correspondence Address: THOMPSON HINE L.L.P.;Intellectual Property Group, P.O. BOX 8801, DAYTON, OH, 45401-8801, US

(73) Assignee: SPEAR GROUP HOLDINGS LIMITED, Cwmbran (GB)

(21) Appl. No.: 11/718,721

(22) PCT Filed: Sep. 7, 2006
(86) PCT No.: PCT/GB2006/003329

§ 371 Date: Jan. 2, 2009

(30) Foreign Application Priority Data
Nov. 8, 2005 (GB) 0522780.6

(51) Int. Cl. B65C 9/30

(52) U.S. Cl. 156/60; 156/568

(57) ABSTRACT

Labelling apparatus, for example for applying labels to articles such as bottles by means of a pressure-sensitive adhesive, includes a presser 20 which comprises an array of freely rotatable rollers 22. Each roller 22 has a resilient surface constituted, for example, by a foam rubber sleeve, and is independently resiliently mounted on a common support 24 by means of springs 36. Labels 16 are partially affixed to bottles 4 which are then rotated about their axes as they pass the presser 20. Resilient contact between the rollers 22 and the label 16 cause the label 16 to be pressed against the surface of the bottle 4 to fix it in place.

The invention relates to the labelling of articles, and is particularly, although not exclusively, concerned with the application of labels to bottles, for example glass beverage bottles.

It is known to affix labels to bottles by means of pressure-sensitive adhesives. In a typical process for applying such labels, for example as disclosed in US 2005/0138895, the labels are supplied to an applicator head at a labelling station, at which bottles travel on a circular path past the labelling head. A label is presented to each bottle as it passes the labelling head. The bottle then travels past a presser which presses the label against the surface of the bottle, so as to secure the label to the bottle over its full extent. As each bottle passes the presser, it is rotated about its own cylindrical axis.

In known labelling apparatus, the pressers may take the form of brushes (as disclosed in US 2005/0138895), flexible wiper blades or stationary foam pads.

More recently, it has become common for self-adhesive labels (ie those provided with a layer of pressure-sensitive adhesive for affixing the labels to bottles) to be embossed or to have other formations on their exposed surface to provide, for example, a tactile finish. Such labels have proved difficult to apply using conventional pressers, and furthermore tactile finishes tend to be abrasive, and so significantly reduce the life of known pressers.

According to the present invention there is provided labelling apparatus for applying labels to articles, the apparatus including means for conveying the articles past a presser for pressing a partially-applied label against the article, the presser comprising at least one resilient roller which is positioned to apply pressure to the labels on the articles as they travel past the presser.

The apparatus preferably includes means for rotating each article about an axis passing through the article, during travel of the article past the presser. If the articles are bottles, each bottle may be rotated about its own axis.

In order to ensure that each label is adequately affixed to its respective article, the presser may comprise a plurality of rollers. For example, the presser may have at least four rollers; in a preferred embodiment, the presser has ten rollers.

The rollers are preferably closely spaced apart from each other. For example, the spacing between each two rollers may be less than the diameter of each roller. More preferably, the spacing between each two rollers is less than 5 mm, and may be less than 1 mm.

The rollers preferably have the same dimensions as each other. The rollers may have a cylindrical outer surface, but in some embodiments it may be desirable for them to have other shapes, for example they may taper from a central position towards the axial ends of the roller. The axes of the rollers may lie in a common plane which may be a flat plane, or which may be curved to match the path of the articles.

Each roller may have a resilient surface. For example, each roller may be provided with an elastomeric sleeve which provides the external surface of the roller. The elastomeric material of the sleeve may have a shore A hardness which is not less than 25 and not more than 35. The material may be in the form of a foam.

At least one of the rollers may be supported for free rotation, for example in a carrier which supports opposite ends of the roller by means of bearings. The carrier may be resiliently mounted on a support. At least one of the rollers may be driven, for example, by means of a direct drive or belt drive motor assembly. The speed at which the roller is driven may be matched to the speed at which an outer surface of the article passes the roller.

When a roller which is not driven is used to press the label to the moving article, at the instant that the label is pressed to the article, it is accelerated from rest, or from its free idling speed, to the speed at which the outer surface of the article is moving past the roller. The inertia of the roller causes drag on the label, which could cause damage to the label or cause it to slip relative to the article. This is particularly important for thin or weak labels.

If the roller is driven to rotate prior to pressing the label to the article, this problem is reduced. If the roller is driven to rotate at a speed matched to the speed at which the outer surface of the article passes the roller, the problem is eliminated altogether.

Where the presser comprises a plurality of rollers, all of the rollers may be driven by a common assembly and may be independently and resiliently mounted on a common support. The resilient mounting may be achieved by springs, and the spring force resisting displacement of the or each roller away from the travel path of the articles may be not less than 8 and not more than 40 N. The carrier may be displaceable relative to the support in a direction inclined to a line normal to the travel direction of articles past the presser. The angle of inclination may lie in the range 200 to 400.

According to a second aspect of the present invention, there is provided a presser for use in labelling apparatus as defined above.

According to a third aspect of the present invention, there is provided a method of applying a label to an article, which method comprises partially applying the label to the article, and subsequently conveying the article past a presser comprising at least one resilient roller which contacts the label as the article travels past the presser, thereby to press the label against the surface of the article.

For a better understanding of the present invention, and to show more clearly how it may be carried into effect, reference will now be made, by way of example, to the accompanying drawings, in which: —

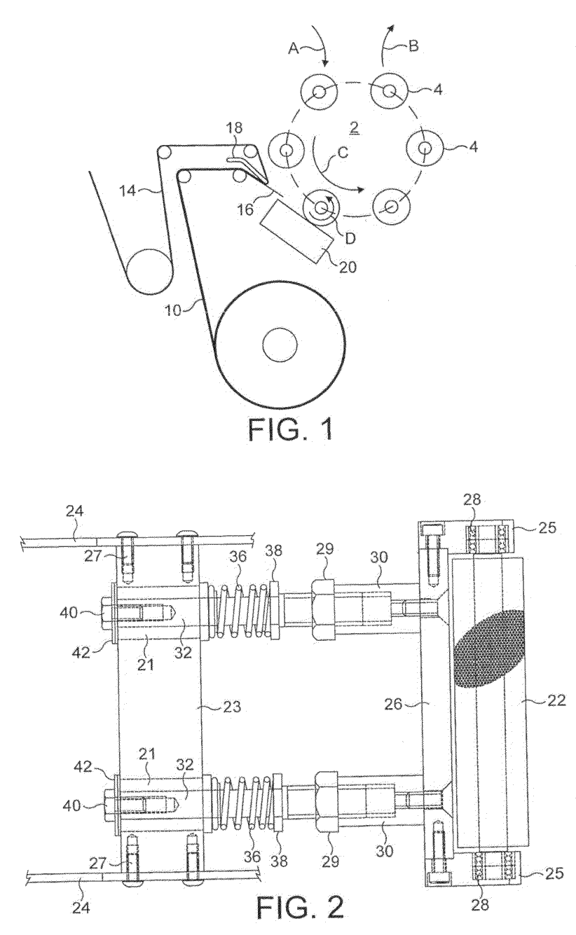

FIG. 1 diagrammatically represents a labelling station of a bottling plant;

FIG. 2 is a side view of a presser of the labelling station of FIG. 1; and

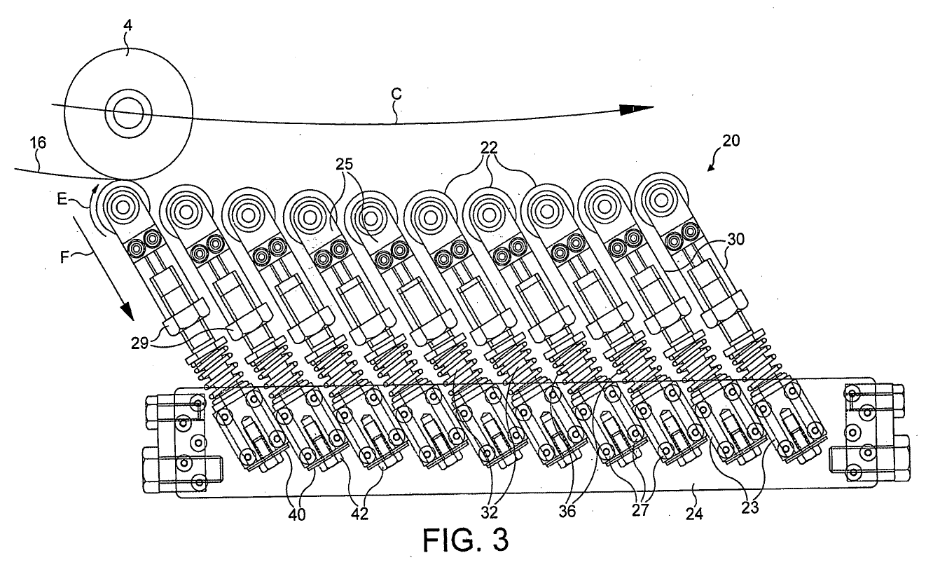

FIG. 3 is a top view of the presser.

The labelling station in FIG. 1 comprises a carousel 2 which receives bottles to be labelled as indicated by an arrow A and returns them to a conveyor for subsequent treatment (for example packaging) as indicated by an arrow B. Thus, rotation of the carousel as indicated by an arrow C conveys the bottles 4 around a circular path in an anti-clockwise direction.

A label web 10 is drawn from a reel 12 and conveyed to a separator device 18. The web 10 comprises a release layer 14 on which individual cut and printed labels 16 are supported. Each label 16 has a layer of pressure-sensitive adhesive on its surface facing the release layer.

The separator device 18 causes the release layer 14 to follow a sharp bend which the labels 16, owing to their greater rigidity, do not follow. Consequently, the labels 16 are peeled from the release layer and are fed into the travel path of the bottles 4. A presser 20 is situated just downstream of the separator device 18, with respect to the travel direction of the projecting label 16.

The label web 10 travels in synchronism with the passage of the bottles 4. Consequently, as each bottle passes the separator device 18, a label 16 is fed towards the bottle. The bottle then progresses to make contact with the presser 20 which presses the leading edge of the label 16 into contact with the bottle 4. The bottle, with the partially attached label 16, then continues to travel past the presser 20. At this stage of its travel, the bottle with the partially attached label 16 is rotated about its axis as indicated by an arrow D, and so draws the label across the presser 20 over the full extent of the label, so as to press it firmly into contact with the surface of the bottle 4. As a result, the label is firmly attached to the bottle 4 by the pressure-sensitive adhesive, without the formation of any creases, wrinkles or air bubbles.

The presser 20 is shown in more detail in FIGS. 2 and 3.

As shown in FIG. 3, the presser 20 comprises ten closely-spaced and freely rotatable rollers 22. The rollers 22 are independently secured between a pair of support plates 24 which is fixed to a stationary part of the labelling apparatus.

The rollers may, for example, have a diameter of 25 mm and the spacing between them may be less than 1 mm.

Consequently, the rollers present, in effect, a continuous surface to the bottles travelling past them, this surface having a length, in the direction of bottle travel, which is sufficient to ensure that each label is contacted by the rollers 22 over the full length of the label, measured in the circumferential direction of the bottle.

As shown in FIG. 2, each roller 22 is carried between the arms 25 of a carrier in the form of a yoke 26. Bearings 28 are provided in each arm 25 to support the roller 22 for free rotation. The yoke 26 is provided with two mounting blocks 30 from which extend plungers 32 which are parallel to each other and spaced apart in the direction of the axis of the roller 22. The plungers 32 extend perpendicular to the axis of the roller 22. The plungers 32 are screwthreaded at their ends engaging the mounting blocks 30, and are adjustable in tapped bores in the blocks 30, with their adjusted positions secured by lock nuts 29.

It will be appreciated that, in some circumstances, adjustment of the lengths of the plungers 32 may not be necessary. In such circumstances, the blocks 30 and lock nuts 29 can be eliminated, with the plungers 32 being directly secured to the yoke 26. Relative positioning of the rollers 22, for example to provide an arcuate arrangement, can be achieved by making the plungers 32 to the appropriate length.

Each plunger 32 extends through a respective opening in a support block 23 which is secured between the support plates 24 by screws 27. A spring 36 acts between the support block 23 and a retaining collar 38 on the plunger 32 in order to bias the roller 22 away from the support block 23. Outward movement of the roller 22 is limited by means of a washer 40 and a bolt 42. Each plunger 32 is slidable in its support block 23 by means of a linear bearing 21 for example a bearing including a self-lubricating polymer such as Frelon®.

The support blocks 23 are secured between the support plates 24 in an inclined orientation relative to a line normal to the row of blocks 23. Consequently, as can be seen from FIG. 3, the plungers 32 are inclined in the upstream direction, with respect to the travel direction C of the bottles 4 as they pass the presser 20.

Each spring has a spring rate within the range 2 to 4 N/mm. The springs 36 are pre-loaded, so that the initial resistance to movement of each roller 22 towards the support 24 is of the order of at least 8 N although, in some applications, the resisting force on each roller 22 may be 40 N or more.

Each roller 22 has a resilient surface. The roller 22 may be made entirely from a suitably resilient material, but preferably the roller comprises a steel core, on which a sleeve of a suitable material is fitted. The material of the sleeve may, for example, be an elastomer such as rubber, and may be sponge or foam rubber. The purpose of the resilient surface of each roller 22 is to ensure that the roller 22 makes contact over the full area of each label 16, even if there are minor irregularities in the surface of the labels or in the outer surfaces of the bottles 4. It has been found that a foam rubber material having a shore A hardness in the range 25 to 35 provides satisfactory results.

Although the rollers 22 shown in FIGS. 2 and 3 are cylindrical over their entire length, it may, in some circumstances, be appropriate to use a non-cylindrical roller. For example, the roller may taper from its middle towards its ends. The effect of this would be to increase the pressure applied to each label 16 in the central part of the label, with the pressure decreasing towards the top and bottom edges of the label with respect to the orientation of the label on a bottle 4. This may be useful in some circumstances to ensure that the label is spread properly over the surface of the bottle 4, so avoiding the entrapment of air bubbles.

In use of the presser as shown in FIGS. 2 and 3 in the labelling apparatus of FIG. 1, there is no sliding movement between the surface of each label 16 and the presser itself. Instead, the relative movement caused by the travel of the bottles 4 around the carousel 2 and their rotation about their own axes is accommodated by the free rotation of the rollers 22 in the yokes 26, as indicated in FIG. 3 by an arrow E. Consequently, wear of the surface of each roller 22 is minimised, and the operational life of the presser 20 is increased. In operation, the rollers may be deflected, by the passing bottles 4, towards the support 24 against the resistance of the springs 36 as indicated by an arrow F. The deflection may not be large (for example of the order of 1 or 2 mm), but this results in a firm pressing of the labels against the bottle surface to ensure good adhesion. Because the plungers 32 are inclined towards the approaching bottles 4, lateral forces applied to the plungers 32 by the bottles 4 are minimised, so reducing wear between the plungers 32 and the linear bearings 21.

As shown in FIG. 3, the position of each roller 32 may be adjusted (by loosening the lock nut 29 and varying the depth of insertion of the plunger 32 into the mounting block 30) so as to arrange the rollers along an arc, or other curve, to conform to the path of the bottles 4, or to adjust the pressure applied to the label 16 as the bottle 4 travels along the presser 20. If an arcuate array is used, as shown in FIG. 3, an even pressure can be achieved over the full extent of the presser 20.

It will be appreciated that the number of rollers 22 required will vary according to the operational parameters of the labelling station as a whole. At one extreme, only a single roller may be adequate, if the label to be applied is relatively short (in the circumferential direction of the bottle) and the rotational speed of the bottle about its own axis is relatively fast. However, in most circumstances, it is envisaged that at least four rollers will be required, whereas in the embodiment described there are ten rollers.

Rotation of the bottles 4 as indicted by the arrow D may not begin until each bottle has traveled past the first one or two of the rollers 22. In that case, the leading edge of the label 16 will be pressed into contact with the bottle by the first roller 22, and the next roller or rollers 22 may simply provide an additional pressing force to the portion of the label 16 which is already attached to the bottle. Only after the bottle 4 begins to rotate will the subsequent rollers 22 act to attach the label 16 fully to the bottle. In alternative arrangements, rotation of the bottle may begin as soon as the label 16 is initially attached, in which case the label 16 may be fully attached after the bottle has passed the fourth roller 22. In such circumstances, the presser 20 may be built with fewer rollers 22 than the ten shown in FIG. 3.

In the arrangement shown in FIG. 3, the rollers are inclined at an angle of 30° to a line normal to the row of rollers 22 (ie to a line normal to the travel path of each bottle 4 past the respective roller 22). Different angles of inclination may be appropriate, depending on the circumstances. The plates 24 may be pre-drilled to enable the blocks 23 to be fitted at different angles, or to be inclined at 30° in the opposite direction to suit a labelling apparatus in which the bottles 4 travel past the presser 20 in the opposite direction from that shown in FIG. 3.

Although the invention has been described in the context of the application of labels to bottles, using a pressure-sensitive adhesive, it will be appreciated that it may also be applied to the labelling of other articles, including articles which are not cylindrical, since the resilient mounting of the rollers can accommodate deviations in the profile of the articles from the purely cylindrical. It may also be used for affixing labels using other kinds of adhesive.

1. Labelling apparatus for applying labels to articles, the apparatus comprising:
a stationary part;
a presser comprising a plurality of rollers mounted resiliently on a common support which is fixed to the stationary part;
label delivery means for partially applying labels to articles;
means for conveying each of the articles past the label delivery means to receive a partially-applied label, and past the presser whereby the rollers of the presser apply pressure to the label on the article.

2. Labelling apparatus as claimed in claim 1, in which means is provided for rotating each article about an axis passing through the article, during travel of the article past the presser.

3. (canceled)

4. Labelling apparatus as claimed in claim 1, in which the presser comprises not less than five rollers.

5. Labelling apparatus as claimed in claim 4, in which the presser comprises ten rollers.

6. Labelling apparatus as claimed in claim 1, in which the spacing between adjacent rollers is not greater than the diameter of each roller.

7. Labelling apparatus as claimed in claim 1, in which the spacing between adjacent rollers is not greater than 5 mm.

8. Labelling apparatus as claimed in claim 7, in which the spacing between adjacent rollers is not greater than 1 mm.

9. Labelling apparatus as claimed in claim 1, in which the axes of the rollers lie in a common plane.

10. Labelling apparatus as claimed in claim 9, in which the common plane is arcuate.

11. Labelling apparatus as claimed in claim 1, in which each roller has a resilient surface.

12. Labelling apparatus as claimed in claim 11, in which each roller is provided with an elastomeric sleeve.

13. Labelling apparatus as claimed in claim 11, in which the shore A hardness of the surface of each roller is not less than 25 and not more than 35.

14. Labelling apparatus as claimed in claim 1, in which at least one of the rollers is mounted for free rotation about its axis.

15. Labelling apparatus as claimed in claim 1, in which each roller is carried by a respective carrier which is resiliently mounted on the support.

16. Labelling apparatus as claimed in claim 15, in which each carrier is resiliently biased away from the support by at least one spring.

17. Labelling apparatus as claimed in claim 16, in which each carrier is mounted on the support by at least one plunger which extends through an opening in the support.

18. Labelling apparatus as claimed in claim 15, in which each carrier is resiliently mounted on the support for resilient displacement in a direction which is inclined to a line normal to the travel direction of articles past the presser.

19. Labelling apparatus as claimed in claim 1, in which at least one of the resilient rollers is a driven roller.

20. A presser for labelling apparatus in accordance with claim 1.

21. A method of applying a label to an article, which method comprises the steps of:
(a) partially applying the label to the article;
(b) subsequently conveying the article past a presser which comprises a plurality of rollers mounted resiliently on a common support which is fixed to a stationary part of the apparatus;
(c) causing the rollers to contact the label resiliently as the article travels past the presser, thereby to press the label against the surface of the article.

22. A method as claimed in claim 21, in which the article is rotated about an axis passing through the article during travel past the presser.

23. A method as claimed in claim 22, in which the article is generally cylindrical and is rotated about its cylindrical axis during at least part of its travel past the presser.

24. A method as claimed in claim 21, in which the article is a bottle.

25. A method as claimed in claim 21, in which the label is fixed to the article by means of a pressure-sensitive adhesive.

26. A method as claimed in claim 21, further comprising the step of driving the or each resilient roller to rotate before the label is pressed to the article.

27. A method as claimed in claim 26, in which the speed at which the or each resilient roller is driven is matched to the speed of the surface of the article.
